(19) United States
(12) Patent Application Publication
(10) Pub. No.: US 2024/0095646 A1
(43) Pub. Date: Mar. 21, 2024

(54) Systems and Methods for Productivity Measurement

(71) Applicant: Advos Pro, LLC, Ponte Vedra, FL (US)

(72) Inventors: Gwendolyn Griggs, Ponte Vedra Beach, FL (US); Whitney Harper, Ponte Vedra Beach, FL (US)

(21) Appl. No.: 18/369,118

(22) Filed: Sep. 15, 2023

Related U.S. Application Data
(60) Provisional application No. 63/407,083, filed on Sep. 15, 2022.

(51) Int. Cl. G06Q 10/067; G06Q 10/0639

(52) U.S. Cl. CPC G06Q 10/067; G06Q 10/0639

(57) ABSTRACT

The present disclosure provides for systems and methods for quantitative and qualitative productivity measurement. A productivity measurement system may comprise at least one point value system, one or more points, and at least one adaptive algorithm. The system may comprise path mapping that connects the current state of a provider to a desired future state. The point value system may comprise at least one adaptive algorithm. The point value system may comprise a general algorithm that becomes an adaptive algorithm as a result of input from one or more assessments and weighted priorities from the provider. These assessments may provide a more accurate productivity measurement than a generic billable hour model. A point may comprise an aggregate of data analysis from an existing provider infrastructure and one or more predetermined parameters submitted by the provider.

### CROSS-REFERENCE TO RELATED APPLICATION

This application is a Non-provisional of and claims priority to U.S. Provisional Patent Application Ser. No. 63/407,083 (filed Sep. 15, 2022 and titled “SYSTEMS AND METHODS FOR QUANTITATIVE AND QUALITATIVE PRODUCTIVITY MEASUREMENT”), the entire contents of which are incorporated herein by reference.

### BACKGROUND

In the professional services industry, professional service providers may invoice clients for work performed at an hourly basis. Consulting firms, public accountants, and legal service firms are amongst the most common examples of companies that traditionally bill by hours of staff time.

One of the more recent industries that turned to the billable hour system is the legal services industry. As the proliferation of the assembly line and its resulting mass production capabilities brought the value of efficiency to the forefront of public consciousness, an attorney at a legal aid society decided they wanted to track hours to make sure legal services were being efficiently provided. It was not until years later that attorneys started to charge for their services based on how long it took to complete the work. Even the American Bar Association itself, a national voluntary bar association comprised of lawyers and law students, started advocating that timekeeping was the best way for an attorney to generate revenue around 1958. Clients eventually started demanding invoices that broke down attorney work by the hour.

As part of this process, each staff member tracks their hours specific to each client or project that they have. This detailed timesheet may capture the types of activities performed for each client and the length of time it took to complete said activities. As part of its review process, a company may determine what constituted billable work hours, administrative work, or other work. A company then bills a client at the end of a set cycle, sending an invoice based on whatever work different staff members have done. Hourly billing rates may be based on a variety of factors, such as a staff member's job title, level of experience, or whether any special skills or knowledge was required for the work performed.

Certain professional service providers require a certain number of billable hours per month or per year. Depending on the service provider's industry, billable hours are sometimes used as a metric to determine how much work is being done, where employees are focusing their time for work, or what type of work is being done.

As time has gone on, billable hours have been seen as a metric for individual worth, where individuals who achieve higher billable hours within a cycle can be perceived as more valuable to a company for billing out to clients at higher rates. One of the criticisms with the creation of the billable hour model is that a person doing more hours of work is not representative of, or tantamount to, higher quality work. Increasing billable hours might create an inherent conflict with the service provider and the client, since more billable hours might not be in service of or in the best interests of a particular client.

The issues that resulted from embracing the billable hour in professional services firms have grown dramatically over the past decade. Increasing hourly demands, rewarding inefficiencies that lead to higher billable hour rates, and using the billable hour as a means to track individual performance have all led to re-assessing the billable hour itself. These range from alternatives to the billable hour itself—sometimes called alternative fee arrangements—to developing technology to further refine the billable hour system. As professional service providers continue to reevaluate and modify the billable hour model, there is still a desire to accurately report on work done for a particular client while reflecting the effort and value of work employees do on a daily basis.

### SUMMARY OF THE DISCLOSURE

What is needed are systems and methods that may function as a substitute for the billable hour model and that may provide a quantifiable and qualitative way to measure, assess, track, or evaluate worker output or performance and to obtain compensation for one or more deliverables that may correlate to or be indirectly or directly associated with worker output or performance. Accordingly, the present disclosure provides for systems and methods for productivity measurement that comprise quantitative and qualitative attributes. In some aspects, a productivity measurement system may be configured to facilitate a conversion between the scope, size, complexity, value, importance, and/or urgency of one or more deliverables and one or more predetermined point values, wherein the point values may be used for measuring worker performance and productivity, as well as for billing clients, customers, or patrons of the provider associated with the worker. In some implementations, the productivity measurement system may comprise at least one point value system, one or more points, and at least one adaptive algorithm. In some embodiments, the productivity measurement system may comprise predictive path mapping that may facilitate a progression from the current state of a provider to an intended or desired future state, which may be at least partially based on business strategy. In some aspects, the point value system may comprise at least one adaptive algorithm. In some implementations, the point value system may comprise at least one general algorithm that may evolve into at least one adaptive algorithm as a result of receiving one or more inputs at least partially comprising, for example and not limitation, assessments and weighted priorities provided by the provider.

In some aspects, each point generated or determined by the productivity measurement system or entered or programmed into the productivity measurement system may at least partially comprise a correlative association with an amount of time required to accomplish a task, project, or similar deliverable. In some implementations, each point may comprise an aggregate of data analysis received or extracted from an existing provider infrastructure and one or more predetermined parameters submitted by a provider. In some embodiments, each point may be at least partially based on the scope, size, complexity, value, importance, and/or urgency of one or more deliverables or similar outputs that may be produced or generated by one or more workers that may be indirectly or directly associated with the provider. In some aspects, the productivity measurement system may comprise at least one adaptive algorithm that may at least partially comprise at least one machine learning process. In some implementations, the adaptive algorithm may be configured to allow the point value system to be modified in response to received data comprising active feedback collected via one or more machine learning processes configured to monitor or track one or more programs of a provider.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates an exemplary algorithm creation for a point value system, according to some embodiments of the present disclosure.

FIG. 1B illustrates an exemplary algorithm creation for a point value system, according to some embodiments of the present disclosure.

FIG. 1C illustrates an exemplary algorithm creation for a point value system, according to some embodiments of the present disclosure.

FIG. 1D illustrates an exemplary algorithm creations or a point value system, according to some embodiments of the present disclosure.

FIG. 2A illustrates an exemplary point value determination process, according to some embodiments of the present disclosure.

FIG. 2B illustrates an exemplary point value determination process, according to some embodiments of the present disclosure.

FIG. 2C illustrates an exemplary point value determination process, according to some embodiments of the present disclosure.

FIG. 3 illustrates an exemplary point value for a point, according to some embodiments of the present disclosure.

FIG. 4A illustrates an exemplary point value of a point within a point value system, according to some embodiments of the present disclosure.

FIG. 4B illustrates an exemplary point value of a point within a point value system, according to some embodiments of the present disclosure.

FIG. 4C illustrates an exemplary point value of a point within a point value system, according to some embodiments of the present disclosure.

FIG. 5A illustrates an exemplary point value of a point within a point value system, according to some embodiments of the present disclosure.

FIG. 5B illustrates an exemplary point value of a point within a point value system, according to some embodiments of the present disclosure.

FIG. 5C illustrates an exemplary point value of a point within a point value system, according to some embodiments of the present disclosure.

FIG. 6A illustrates an exemplary point acquisition, according to some embodiments of the present disclosure.

FIG. 6B illustrates an exemplary point acquisition, according to some embodiments of the present disclosure.

FIG. 7 illustrates a plurality of exemplary point values associated with a point within a point value system, according to some embodiments of the present disclosure.

FIG. 8A illustrates an exemplary client user interface, according to some embodiments of the present disclosure.

FIG. 8B illustrates an exemplary client user interface, according to some embodiments of the present disclosure.

FIG. 9 illustrates an exemplary employee user interface, according to some embodiments of the present disclosure.

FIG. 10A illustrates an exemplary administrative user interface, according to some embodiments of the present disclosure.

FIG. 10B illustrates an exemplary administrative user interface, according to some embodiments of the present disclosure.

FIG. 10C illustrates an exemplary administrative user interface, according to some embodiments of the present disclosure.

FIG. 11 illustrates a diagram for an exemplary machine learning process for a point value system, according to some embodiments of the present disclosure.

FIG. 12 illustrates an exemplary diagram for an exemplary machine learning process for a point value system, according to some embodiments of the present disclosure.

FIG. 13 illustrates an exemplary flow diagram for the generation of points for a point value system, according to some embodiments of the present disclosure.

FIG. 14 illustrates methods steps for an exemplary process for developing a point value system for a provider, according to some embodiments of the present disclosure.

FIG. 15 illustrates an exemplary computing system that may be used to implement computing functionality for one or more aspects of a productivity measurement system, according to some embodiments of the present disclosure.

### DETAILED DESCRIPTION

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Provider: as used herein refers to the primary user of a productivity measurement system. In some non-limiting exemplary embodiments, a provider may comprise a corporation, firm, business, company, organization, or similar entity. In some implementations, a provider may comprise a plurality of workers, such as, for example and not limitation, employees. In some aspects, a provider may comprise one or more customers, clients, or patrons that may purchase or otherwise obtain or receive one or more deliverables, such as one or more goods, products, or services produced by or available from the provider. In some embodiments, a provider may use one or more portions of a productivity measurement system to facilitate one or more interactions with one or more workers or one or more customers, clients, or patrons, as non-limiting examples.
Point: as used herein refers to a numeric value that comprises a quantified representation of one or more predefined parameters or metrics set by a provider, which may include such factors such as project or task completion time, worker or employee effort, worker or employee expertise, project or task size or scope, project or task complexity, project or task value, project or task importance, or project or task urgency, as non-limiting examples. In some embodiments, points may be applied to one or both of: work product or deliverables intended for customers, clients, or patrons external to a provider and administrative work, projects, or tasks internal to the provider to measure productivity, results, and deliverables for all aspects of a provider's endeavors.
Point value: as used herein refers to the parameters or metrics associated with a point. In some implementations, a point value may comprise one or more worker-related attributes such as, but not limited to: effort, expertise, project or task completion time, or project or task complexity. In some embodiments, a point value may be manually altered or set by a provider based on one or more factors such as, for example and not limitation, project or task completion time, worker or employee effort, worker or employee expertise, project or task size or scope, project or task complexity, project or task value, project or task importance, or project or task urgency, as non-limiting examples.
Map path: as used herein refers to a set of one or more tasks that may assist a provider in progressing from an initially assessed current state to one or more of a plurality of predetermined goals, wherein each goal may comprise a desired or targeted future state. In some non-limiting exemplary embodiments, a map path may be segmented. In some implementations, a provider may receive a plurality of map paths iteratively, wherein each subsequent map path may comprise process improvement.
Program: as used herein refers to one or more portions of a provider's existing infrastructure. In some embodiments, a program may comprise an outline of an existing business model of a provider. In some implementations, a program may comprise a plurality of assessments that may allow a point value system of a productivity measurement system to quantify a provider's current state of performance in at least one predetermined area of focus. By way of example and not limitation, the complexity of a provider's existing client management software (“CMS”) may prevent a direct upload of a company's infrastructure, including performance metrics for its employees. In some aspects, a point value system may be configured to suggest point values for one or more projects or tasks based at least partially upon one or more received answers or responses to one or more questions or prompts. By way of example and not limitation, the expected number of hours required to complete a project may be incorporated as a factor in determining suggested point values.
Point purchase: as used herein refers to a monetary transaction wherein a provider may receive or obtain one or more points as the result of the transaction.
Machine learning: as used herein refers to the use and development of computer systems and processes that are able to learn and adapt without following explicit instructions by using algorithms and statistical models to analyze and draw inferences from patterns in data. Throughout the present disclosure, the term “machine learning” may also refer to one or more artificial intelligence systems, processes, and/or models.
Production category: as used herein refers to one or more projects, tasks, activities, services, or similar deliverables that may be offered by a provider and may be available to one or more actual or potential clients, customers, patrons, or similar recipients for purchase, sale, transfer, or similar transaction. By way of example and not limitation, a production category may comprise a matter or business affair handled or tended to by a provider on behalf of a client or customer.
Deliverable: as used herein refers to a project, task, activity, service, or similar offering that may be completed, performed, or executed, either directly or indirectly, by a provider during the course of engagement of a production category by the provider.

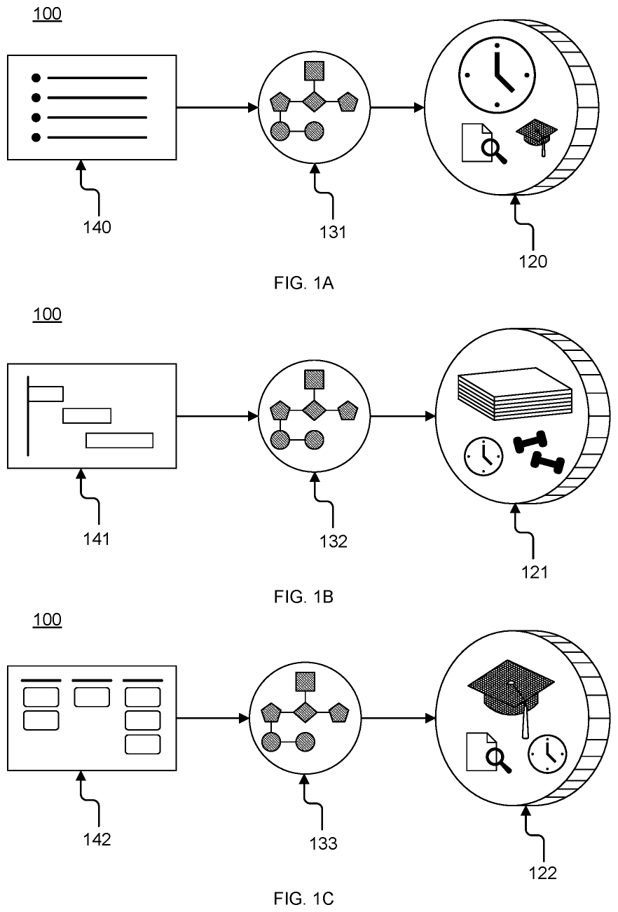

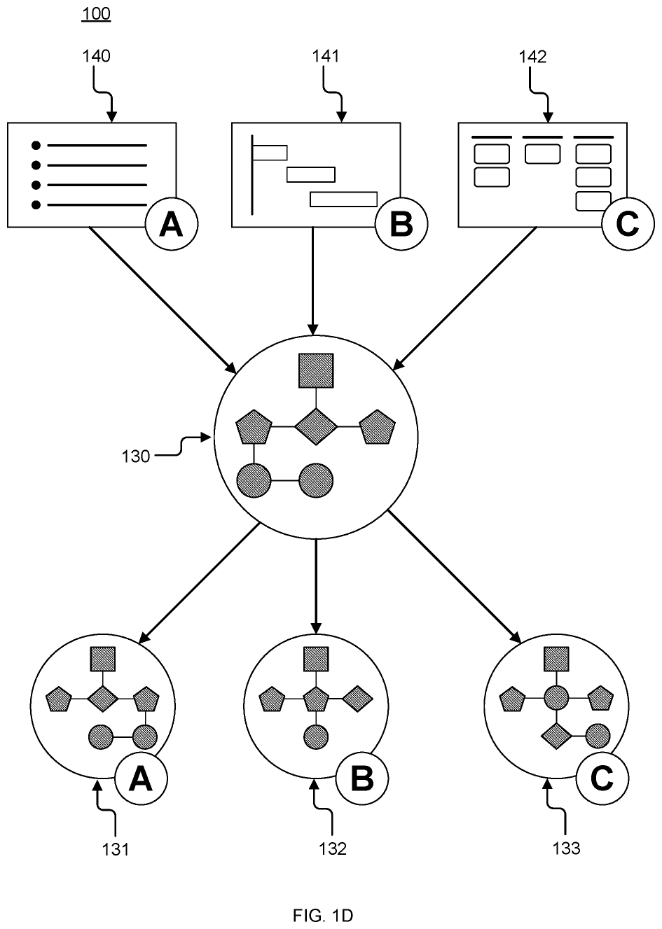

Referring now to FIGS. 1A-1C, an exemplary algorithm 131, 132, 133 creation for a point value system 100, according to some embodiments of the present disclosure, is illustrated. In some aspects, the point value system 100 may be configured to convert a provider's existing billable hour model into one or more points comprising one or more point values. In some implementations, the point value system 100 may be configured to receive at least one program 140, 141, 142 from at least one provider. In some implementations, the point value system 100 may comprise at least one algorithm 131, 132, 133 that may be configured to weigh one or more existing parameters within the program 140, 141, 142 and assign at least one point value 120, 121, 122 to one or more of the parameters.

In some aspects, each point value 120, 121, 122 may be unique to the program 140, 141, 142. In some embodiments, each point value 120, 121, 122 may comprise one or more associative parameters such that the point values 120, 121, 122 may form a representative association with one or more predetermined components within the program 140, 141, 142 if varying importance or significance. In some implementations, the point values 120, 121, 122 may be associated with services or products purchased by the provider's customers, clients, or patrons. In some aspects, the point values 120, 121, 122 may replace a billable hour model in determining prices for the provider's goods or services, wherein the point values 120, 121, 122 may be configured to account for other parameters or factors in addition to or instead of work, project, or task completion time, such as, for example and not limitation, task or project urgency. As a non-limiting illustrative example, a provider may offer a 30-minute consultation for 2 points if the consultation occurs on the day of the request, or the provider may offer the 30-minute consultation for 1 point if scheduled a week ahead of time.

In some aspects, the point values 120, 121, 122 may be associated with productivity measurements for employees or workers of the provider. In some implementations, the point value system 100 may allow the employees to be gauged by a customized set of one or more productivity parameters. In some aspects, these parameters may replace the provider's billable hour model by focusing on the quantity and/or quality of deliverables.

In some embodiments, a plurality of algorithms 131, 132, 133 may be configured to provide or determine a plurality of point values 120, 121, 122 to be associated with at least one point value system 100. By way of example and not limitation, the algorithm 131, 132, 133 may be configured to produce or determine one or more point values 120, 121, 122 to be associated with a provider's customer or client services and a separate set of one or more point values 120, 121, 122 for internal use to measure, gauge, or assess employee productivity and effectiveness.

As a non-limiting illustrative example, an algorithm 131 may be configured to use one or more machine learning processes to develop the ability to recognize that a program 140 for a provider comprises projects or tasks primarily associated with drafting, revising, negotiating, counseling, advising, collaborating, and/or research activities, as non-limiting examples. In some aspects, the frequent or common nature of these activities within the program 140 may cause the machine learning processes of the point value system 100 to encode the algorithm 131 to interpret which tasks may need to be weighted higher than other tasks, such that a higher point value 120 may be assigned to tasks with a higher weight. By way of example and not limitation, the program 140 may comprise one or more smaller tasks, such as research, that may be smaller portions of one or more larger related tasks, and so the algorithm 131 may determine that the smaller tasks may comprise a smaller point value 120 than the larger tasks. In some implementations, the algorithm 131 may recognize that evaluative summaries that comprise a compilation of completed research tend to take more of the provider's time and use employees that have a higher level of expertise. Accordingly, the algorithm 131 may assign a higher point value 120 to tasks that comprise higher complexity and demand more of the provider's resources.

In some embodiments, the algorithm 131 may comprise a plurality of steps within a predefined process. In some implementations, the algorithm 131 may comprise one or more assessments and at least one weighted stack ranking of priorities. In some aspects, the algorithm 131 may comprise at least one analysis of one or more responses to one or more queries that may allow the algorithm 131 to develop an artificial intelligence model that understands the goals, priorities, and pain points of the provider, as non-limiting examples of attributes. In some embodiments, the algorithm 131 maybe configured to generate and present one or more types of high level information to the provider that may be associated with one or more of the provider's needs such as, for example and not limitation, one or more depictions of a provider journey or a business model canvas, as non-limiting examples.

In some implementations, the algorithm 131 may be configured to complete at least one initial assessment of the current state of the provider's program 140 and generate and present at least one map path to one or more predetermined goals of the provider. In some aspects, this assessment may provide the provider with one or more insights into the productivity of the provider's employees or workers. In some embodiments, the algorithm 131 may be configured to generate and present a plurality of map paths that reflect the provider's process improvement over time.

In some aspects, the map paths generated by the algorithm 131 may be used as milestones, such that the progress of the provider's improvements may be quantified by one or more points. In some implementations, quantifying the provider's progress using points may allow the points to be defined in a customized manner unique to a provider's specific productivity indicators, such that the points may provide more relevant and useful productivity insight than the generic metrics of a billable hour model. In some embodiments, the pace or rate at which map paths are generated or produced may be controlled by the provider. In some implementations, the provider or the provider's customer or client may be able to submit approval for one or more phases depicted by one or more map paths.

In some aspects, the algorithm 131 may be configured to determine at least one point value 120 for at least one task, project, or activity. In some embodiments, each point may comprise at least one decimal, fraction, or whole number. In some implementations, the point value system 100 may allow a provider to submit one or more inputs that may cause the algorithm 131 to assign one or more predetermined point values 120 that correlate to one or more predetermined types or amounts of effort. In some aspects, at least one generic algorithm 132 may be configured to form a baseline set of point values 121 from a program 141. In some implementations, active monitoring of components across various project types may facilitate predictable point usage for similar projects. In some aspects, the algorithm 131 may detect unique variables within projects that may result in a different point allocation recommendation.

In some embodiments, the generic algorithm 132 may be applied to a plurality of programs 141, 142. As a non-limiting illustrative example, a corporation may use different project management systems for its accounting division and its engineering division. In some aspects, the corporation may utilize at least one preformulated algorithm 132 to establish a baseline expectation of how to price a plurality of services available from the provider based on the relativity of other services offered by the corporation. In some implementations, an algorithm 132 may be applied to a plurality of programs 141, 142 simultaneously.

As a non-limiting illustrative example, a corporation may desire to use a generic algorithm 132 to compare relative pricing for services between its accounting and consulting departments. In some aspects, the corporation may utilize cross-department point values 120, 121, 122 to group services and offer incentive packages to clients or customers. In some implementations, the algorithm 131, 132, 133 may comprise an active monitoring aspect that utilizes one or more machine learning processes to optimize the point value system 100 based upon current implementations. In some embodiments, the algorithm 131, 132, 133 may comprise machine learning to automate one or more assessments, scores, or weight issues or to auto-generate a work plan for each scope of services, as non-limiting examples.

In some implementations, each assessment facilitated by the algorithm 131, 132, 133 may comprise one or more processes such as provider journey mapping or a business model canvas, as non-limiting examples. In some aspects, the algorithm 131, 132, 133 may at least partially comprise one or more gamified training modules, which may incentivize progress by allowing users to “level up” as they complete assessments and the subsequently generated work plan. In some embodiments, the algorithm 131, 132, 133 may provide one or more alternative incentives to progress and growth. In some aspects, in contrast to the billable hour model, progress may be measured by the point value system 100 in terms of how many assessments, deliverables, and respective work plans have been implemented or completed, as non-limiting examples, which may, for example and not limitation, encourage, promote, or reward efficiency.

In some embodiments, the algorithm 133 may comprise a standardized analysis of a program 140, 141, 142. In some implementations, the algorithm 133 may complete a superficial scan of the program 140, 141, 142 that allows the algorithm 133 to quantify the number of repeated tasks within the program 140, 141, 142 and their respective frequencies. In some aspects, the algorithm 133 may be configured to correlate task frequency to point value 122. In some embodiments, a provider may request a predetermined weight to be assigned to one or more predefined parameters.

Referring now to FIG. 1D, an exemplary algorithm 130 creation for a point value system 100, according to some embodiments of the present disclosure, is illustrated. In some implementations, an algorithm 130 may be configured to generate or produce a plurality of personalized or customized algorithms. In some aspects, the personalized or customized algorithms may allow a provider to customize the price of a product or service, as non-limiting examples, according to one or more predetermined parameters set by the provider. In some embodiments, a personalized or customized point value system 100 may provide more accurate estimates of work product cost and pricing than generic metrics, such as, for example and not limitation, those that may be established by a billable hour model.

In some implementations, an algorithm 130 may be configured to receive one or more programs 140, 141, 142 from a plurality of different firms or companies, as non-limiting examples of providers. In some aspects, the algorithm 130 may be configured to generate or produce one or more unique algorithms 131, 132, 133 that may be developed based at least partially on the internal configuration of each provider.

As a non-limiting illustrative example, an algorithm 130 may be configured to conduct, execute, or perform a cursory scan of at least one submitted program 140, 141, 142 that enables the algorithm 130 to notate that most tasks or projects are completed by the provider past their deadlines or due dates. In some aspects, the algorithm 130 may become personalized or customized to the program 140, 141, 142 as the algorithm 130 uses the aggregated task analysis to formulate an associative correlation between different tasks and their perceived point value. In some implementations, the algorithm 130 may also be configured to integrate feedback from one or more automated assessments. In some embodiments, the provider may be able to submit one or more inputs to define one or more categories for the algorithm 131 to associate with one or more point values.

In some non-limiting exemplary embodiments, the algorithm 130 may determine that time is the highest valued asset or attribute for the provider's customers or clients, and do the algorithm 130 may associate the highest point value with the quantity of time required to complete a task, project, or activity. In some aspects, by way of example and not limitation, additional products associated with point values may comprise a professional case analysis or targeted business research. In some implementations, the algorithm 130 may become personalized or customized to a provider as correlations are made between one or more defined variables of a program 140, 141, 142 and one or more point values.

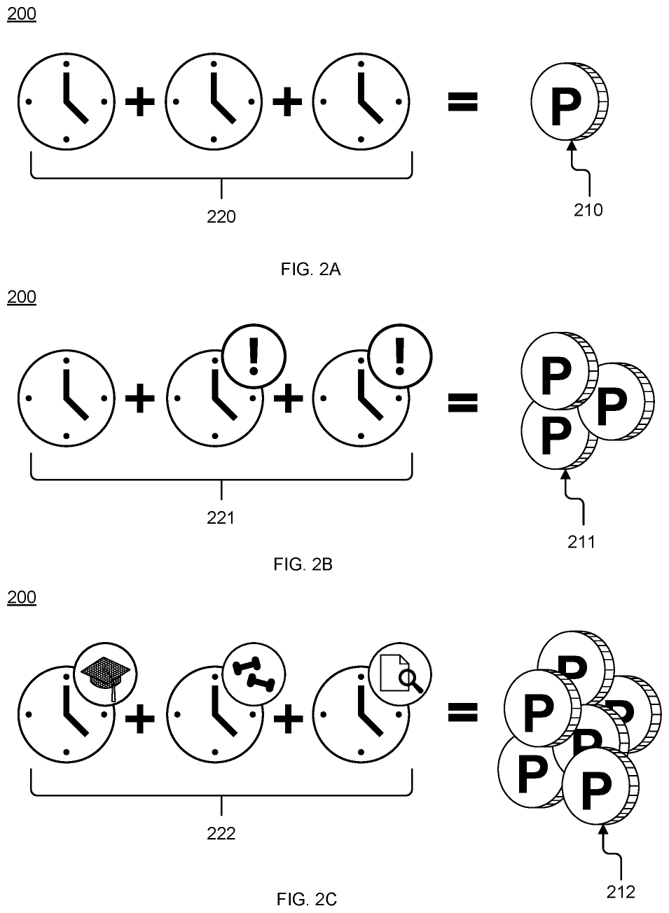

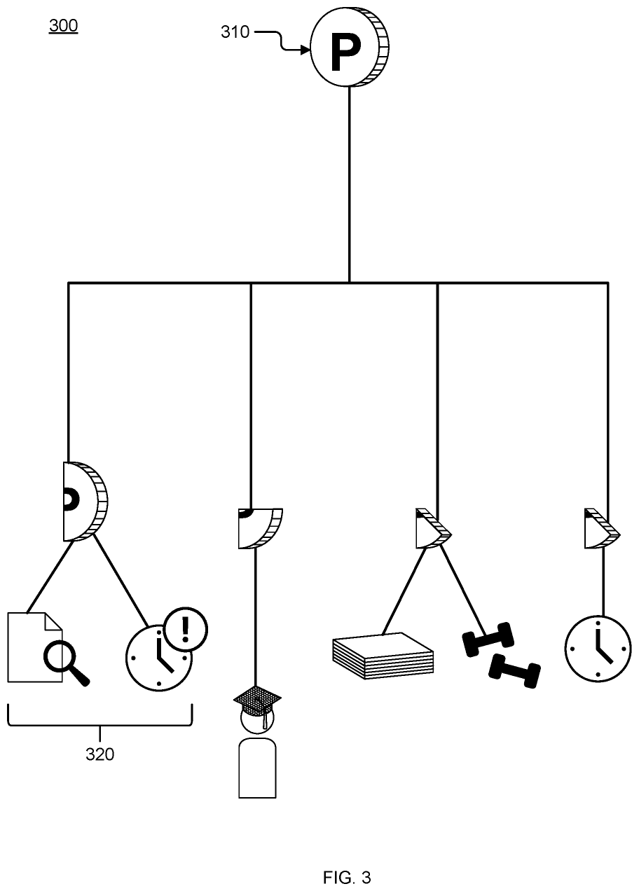

Referring now to FIGS. 2A-2C, exemplary point value 220, 221, 222 determination processes, according to some embodiments of the present disclosure, are illustrated. In some aspects, a point value system 200 may be configured to determine one or more unique point values 220, 221, 222 for one or more points 210, 211, 212. In some non-limiting exemplary embodiments, a point 210 may comprise a predetermined amount of time. In some implementations, the urgency of the required timeframe for completion of at least one task, project, or activity may affect the quantity of points 210 associated with completion of the request task, project, or activity. In some aspects, factoring urgency into the quantity of points 210 associated with task completion may overcome a short-coming of the billable hour model: namely, the billable hour is an inflexible metric that cannot distinguish the intensity of effort invested in completing a task within a predetermined amount of time.

By way of example and not limitation, a predetermined amount of time for completion of a project, task, or activity that has been scheduled a month prior to beginning the task, project, or activity may be correlated with a point value 220 that may only comprise two points 210. In some aspects, completion of an identical task, project, or activity may comprise four points 211 if the task, project, or activity is requested with only two weeks before the required completion date. In some implementations, this compressed deadline may cause the associated point value 221 to increase accordingly. In some embodiments, the increase in point value 221 may reflect the intensity of effort required to complete the task, project, or activity within the shortened timeframe.

In some aspects, a provider may charge a point 210 in exchange for a predetermined amount of the provider's time or for one or more deliverables offered by the provider. As a non-limiting illustrative example, a week of a first provider's time on a specific project or task may cost 10 points 210 for the relevant customer, client, or patron, whereas a second provider may charge 10 points 210 for a month of time on a specific project. In some embodiments, these generalized prices may apply to a generic task such as a targeted data search, as a non-limiting example.

In some implementations, the difference between providers and their respective point values may demonstrate a beneficial aspect of the point value system 200, which places weight on one or more factors that may be difficult to quantify, such as effort or expertise, as non-limiting examples. In some aspects, the billable hour method may be insufficient to define the difference between providers based solely on a non-descriptive linear metric such as billable hours.

In some embodiments, a point value 222 may comprise a combination of one or more parameters or attributes, such as proficiency, complexity, or skill, when determining the point value 222 for one or more generalized tasks. In some implementations, one or more points 212 may comprise a point value 222 that comprises a weighted computational analysis of a plurality of employee or worker tasks or activities and one or more parameters or characteristics associated therewith, such as drafting, revising, negotiating, counseling, advising, collaborating, research, intensity of effort needed, and required expertise, as non-limiting examples.

In some aspects, expedited time for a project, task, or activity may comprise a higher point value 221 than normally scheduled time or standard pace time. By way of example and not limitation, if a provider is asked to complete a project or task in two weeks that would normally take a month, then the project may cost the client or customer more points 211. In some aspects, expedited time may be at least partially determined by labor type. In some embodiments, expedited time may be longer for larger projects and shorter for smaller projects. As a non-limiting illustrative example, expedited time on a six-month long project may cost a customer or client five points 211, and expedited time on a two week project may cost a customer or client one and a half points 210.

In some aspects, a point value 222 for employee productivity may be at least partially determined by effort, expertise, or one or more other non-limiting factors. In some implementations, more effort, as quantified by deliverable-associated time, by an employee or worker toward a project may generate more points 212 for the employee or worker. In some implementations, prior research regarding a project may produce additional productivity points 212 for the employee or worker. In some aspects, a project that may comprise a specific expertise may increase the point value 222 for the employee or worker.

Referring now to FIG. 3, an exemplary point value 320 for a point 310, according to some embodiments of the present disclosure, is illustrated. In some implementations, the point 310 and its associated point value 320 may be generated by and/or used within a point value system 300. In some embodiments, a point value 320 may be different for different point value systems 300. In some aspects, a point value 320 may comprise a combination of smaller point values for smaller tasks within an overall project, task, or activity.

As a non-limiting illustrative example, the point value 320 of a project may comprise a sum of the point values associated with all tasks within the project. In some aspects, the project may comprise a matter compilation that may involve a plurality of subtasks such as drafting, revising, negotiating, counseling, advising, collaborating, or research, as non-limiting examples. By way of example and not limitation, research and drafting, may comprise point values of 0.75 and 1.25 points, respectively. In some non-limiting exemplary implementations, the point value 320 of the matter compilation project may comprise the combined point value 320 of both research and drafting. In some aspects, each partial value of a total point value 320 may allow the point value system 300 to precisely estimate complex considerations such as effort and expertise, whereas a billable hour model lacks the capacity to accurately describe similarly nuanced intricacies.

In some implementations, a plurality of factors may determine a point value 320. In some aspects, the point value system 300 may be altered based on one or more inputs received from or requested by a provider. In some embodiments, the point value 320 may be determined by more than one aspect. By way of example and not limitation, a point 310 may comprise a higher point value 320 based on the type of research being conducted as well as the amount of time it takes.

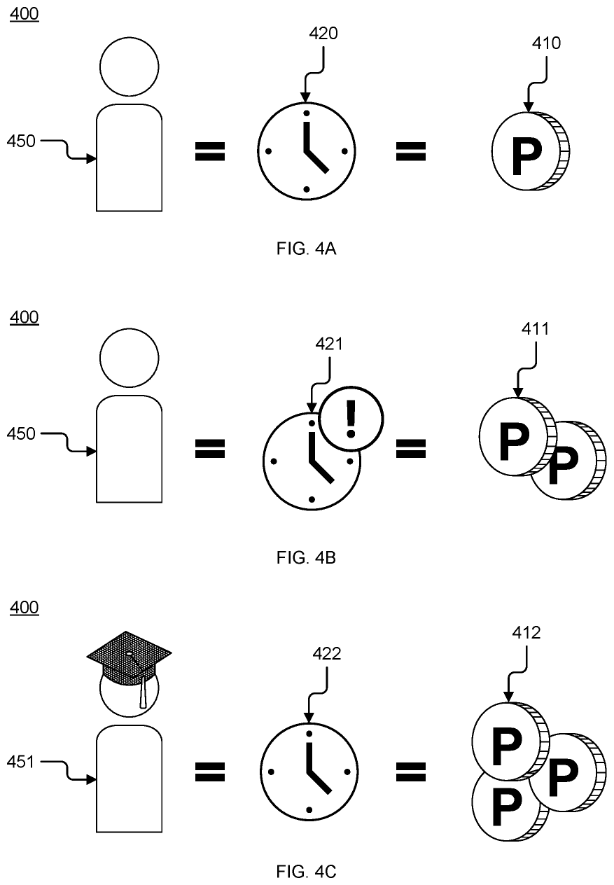

Referring now to FIGS. 4A-4C, exemplary point values 420, 421, 422 of points 410, 411, 412 within a point value system 400, according to some embodiments of the present disclosure, are illustrated. In some aspects, a worker or employee 450, 451 of a provider may perform one or more services or produce one or more products that may correlate to variable quantities of points 410, 411, 412. In some implementations, an employee 450 may produce a plurality of points 410, 411 as a function of time. In some embodiments, two or more employees 450, 451 may work on the same project and receive a portion of the points 411, 412 that may be associated with completion of the project. In some aspects, the total points 411, 412 associated with the contribution of the employees 450, 441 may exceed the total number of points a client or customer allocated towards the projects, thereby promoting collaboration amongst the employees 450, 451. As a non-limiting illustrative example, an associate and a paralegal may contribute to the same project with the associate being allocated two points and the paralegal being allocated one.

In some aspects, the level of expertise an employee 451 possesses may affect the number of points 412 the employee may be allocated. In some embodiments, two or more employees 451 may receive the same amount of points 410 for completing a task if they possess the same or substantially similar credentials. As a non-limiting illustrative example, an employee 451 with a Master's degree in biophysics may be able to provide a more in-depth analysis of the current opportunities in the relevant field of innovation than an employee 450 without the same expertise. In some embodiments, one or more performance metrics such as time, expertise, or project or task complexity, as non-limiting examples, may be used to correlate employee 450, 451 labor with points 410, 411, 412.

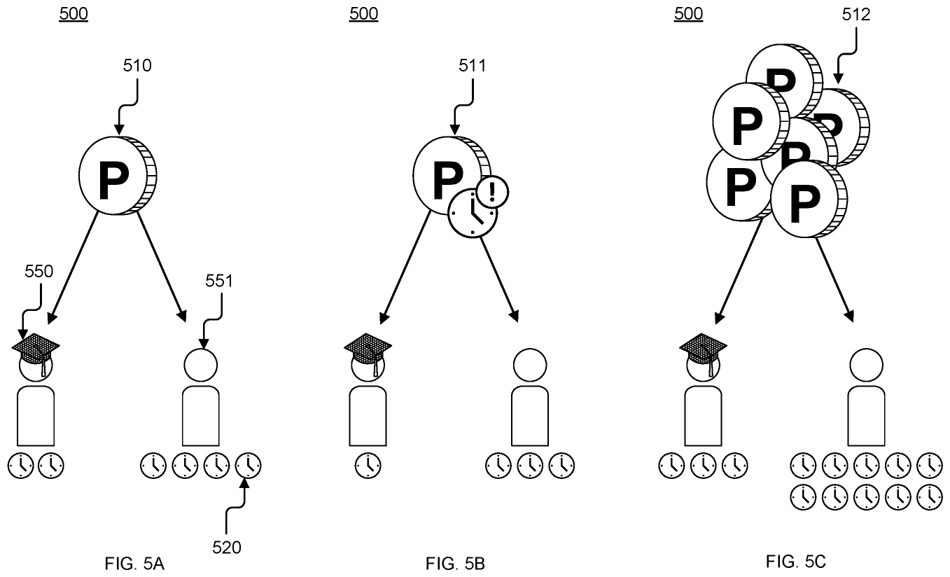

Referring now to FIGS. 5A-5C, exemplary point values 520 of points 510, 511, 512 within a point value system 500, according to some embodiments of the present disclosure, are illustrated. In some aspects, the formation or determination of a point value 520 may comprise the efforts of a plurality of employees 550, 551. In some implementations, a point 510 may comprise a variable quantity of effort from a plurality of employees 550, 551. In some aspects, the quantity of available time and effort may increase for points 511 expended with expedited constraints, wherein an increased quantity of required time and effort may be associated with a shorter timeline for completion of a project or task. In some implementations, this variability may facilitate the ability of the point value system 500 to modify a point value 520 based on effort, which may increase point value 520. In contrast, a billable hour model may only provide information on the decreased number of hours available to complete the task.

As a non-limiting illustrative example, a patent agent may be primarily responsible for formulating the first draft of a response to a legal office action for a law firm, which may consume a large quantity of time and effort. In some aspects, the patent agent may submit the completed draft to an attorney who may review and add to the content of the office action response. In some implementations, the attorney's review of the patent agent's draft may require less time but more expertise than was required to complete the first draft. In some embodiments, the total point value 520 of the office action response may account for the time, effort, and expertise contributed by both the patent agent and the attorney.

In some embodiments, a plurality of points 512 may comprise a predetermined portion of a plurality of employees 550, 551 time, effort, and expertise. In some implementations, a greater quantity of points 512 may comprise greater resource allocations for the intent of completing a project, as a non-limiting example.

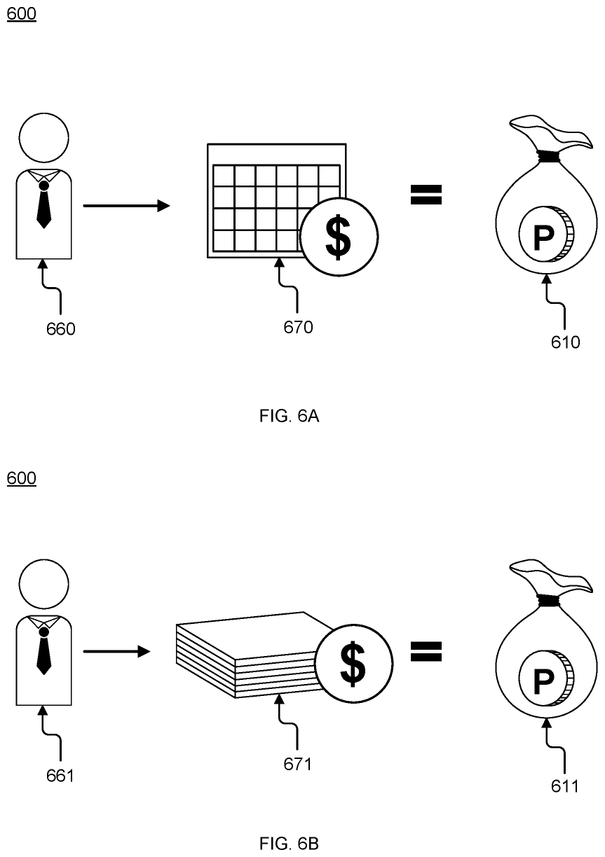

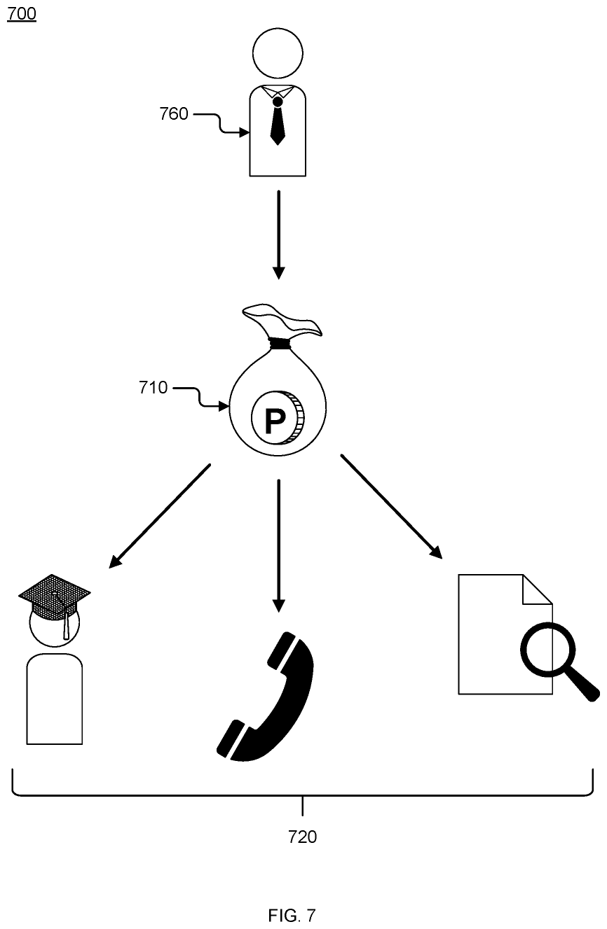

Referring now to FIG. 6A, an exemplary point 610 acquisition, according to some embodiments of the present disclosure, is illustrated. In some non-limiting exemplary implementations, a point 610 acquisition may comprise a subscription-based point purchase 670. In some aspects, a customer, patron, or client 660 may purchase one or more points 610 from a provider at one or more predetermined time intervals. In some embodiments, the point purchase 670 may comprise a subscription. In some implementations, the quantity of points 610 purchased with the subscription may be modified at a variable rate.

By way of example and not limitation, a first recurring point purchase 670 by a client 660 may comprise five points 610; however, the next scheduled point purchase 670 may comprise a purchase of ten points 610. In some aspects, the recurring purchases of the points 610 may be cancelled by the provider or client 660 with notice. In some embodiments, the client 660 may retain previously purchased points 610 upon cancellation. In some implementations, an account associated with the client 660 may retain the remaining points 610 upon cancellation and be reactivated when the client 660 resumes a point purchase 670 plan. In some implementations, the recurring point purchase 670 may occur monthly, weekly, or annually, as non-limiting examples.

In some aspects, unused points 610 may carry over into the client's 660 account into a subsequent point 610 cycle or period. By way of example and not limitation, if a client 660 only uses four out of five points 610 allocated for a point 610 period, then one point 610 may carry over to be added to the next subsequent recurring point purchase 670. In some aspects, these recurring points 610 may combine with previous unspent or unused points 610.

By way of example and not limitation, if one point 610 is left over and another five points 610 are purchased, then the client 660 may have six points 610 total to use or spend. In some aspects, by way of example and not limitation, the following recurring point purchase 670 of five points 610 may comprise the addition of two unused points 610, thereby resulting in the client 660 possessing a total of seven points 610. In some implementations, the carry over of unused points 610 may enable a point value system 600 to comprise a versatility that may be lacking in a generic billable hour model, wherein although remaining billable hours may be attributed to the completion of future projects, the hours will be used for the same amount of time as previously conserved. In contrast, unused points 610 within the point value system 600 may be applied to projects that may result in a different amount of time than they may have been associated with original point value of the conserved points 610.

By way of example and not limitation, four leftover points 610 may be used to purchase an expedited project that comprises a condensed timeline, or four leftover points 610 may be used to purchase eight smaller tasks worth half a point 610 each. Collectively, the time required to complete all eight tasks may be greater than the amount of time the original four points 610 would have purchased in the original project for which the points 610 may have been allocated.

In some aspects, this variability may be possible due to non-linear variables used in the point value system 600, such as worker or employee effort; project, task, or activity urgency; project, task, or activity complexity; or worker or employee expertise, as non-limiting examples. To further illustrate the previous example, the eight tasks worth half a point 610 each may collectively take a longer amount of time to complete, but the nature of the combined tasks may comprise a significantly lower level of rigor, thus decreasing its total point value.

In some aspects, a first client 660 may share unused points 610 with one or more second clients 661. In some non-limiting exemplary embodiments, the remaining balance of the points 610 of a first client 660 may be transferred to a second client 661 upon cancellation of a subscription point purchase 670 of the first client 660.

Referring now to FIG. 6B, an exemplary point 611 acquisition, according to some embodiments of the present disclosure, is illustrated. In some non-limiting exemplary implementations, an acquisition of one or more points 611 may comprise a point purchase 671. In some aspects, one or more points 611 may be purchased based at least partially upon one or more project, task, or activity demands, needs, or requirements. By way of example and not limitation, a project that expands in scope during the pendency of the project may indicate that the points 611 required for completion of that particular project may need to be increased accordingly. In some implementations, different projects, tasks, or activities may possess a plurality of point values. As a non-limiting illustrative example, a client 661 may request completion of a project that comprises research, data analysis, and an expert summary. In some aspects, the point value for the project may increase with the requirement of an expert analysis whereas a project that comprises only a cursory search and related search report may comprise a lower point value. In some non-limiting exemplary implementations, a client 661 may purchase a plurality of points 611 in the form of a plurality of projects purchased simultaneously, wherein the plurality of projects may be purchased at a discounted rate.

Referring now to FIG. 7, a plurality of exemplary point values 720 associated with a point 710 within a point value system 700, according to some embodiments of the present disclosure, is illustrated. In some non-limiting exemplary implementations, a point 710 may comprise a plurality of point values 720. In some aspects, a customer, patron, or client 760 may choose to complete a purchase from any combination of a plurality of services, products, or deliverables with one or more points 710. As a non-limiting illustrative example, a client 760 may purchase a project package that may comprise detailed research into an intended field of business, a professional analysis of the best strategy for market entry, and one or more detailed or brief phone conversation(s) outlining the client's next steps in launching a product into the intended market.

In some embodiments, a client 760 may purchase one or more predetermined services with one or more points 710. By way of example and not limitation, the client 760 may only use their points 710 on labor, rather than documentation, items, consultations, or other non-limiting examples. In some aspects, the client 760 may use or spend points 710 on worker or employee labor on a project, consultations, research, or one or more other non-limiting examples.

In some aspects, a client 760 may be associated with one or more unique point values 720 for one or more points 710. By way of example and not limitation, a first client 760 may require eight points 710 to have research completed due to its specialized nature, while a second client 760 may only require six points 710 to have research conducted that may be of a more generalized nature. In some implementations, this difference in point values 720 may allow the point value system 700 to account for characteristics of a provider's 760 services such as proficiency at completing a task or effort required to complete a task, as non-limiting examples of parameters or attributes that may be difficult to account for in a billable hour model.

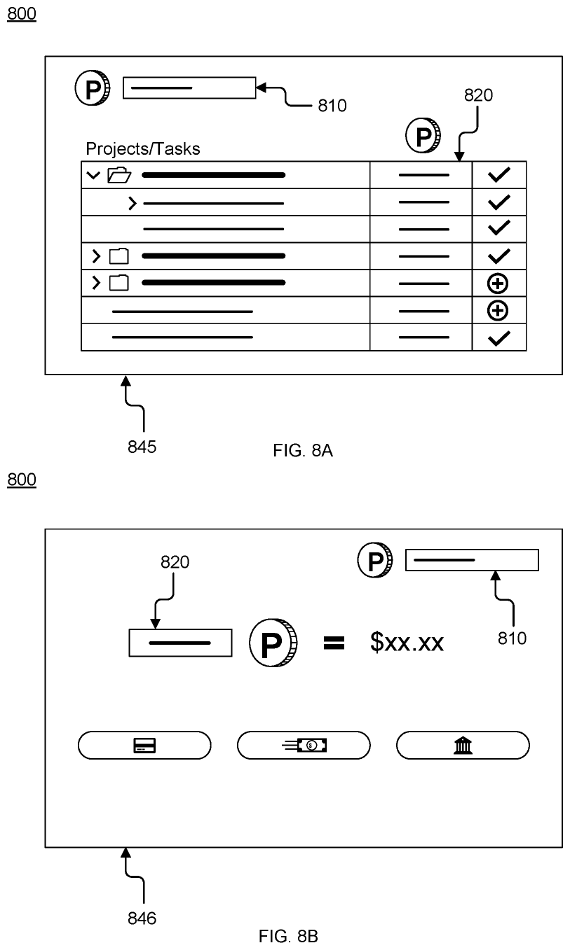

Referring now to FIGS. 8A-8B, exemplary client user interfaces 845, 846, according to some embodiments of the present disclosure, are illustrated. In some implementations, the client user interfaces 845, 846 may be generated and presented by a productivity measurement system 800. By way of example and not limitation the client user interfaces 845, 846 may be presented via at least one display screen integrated with or communicatively coupled to at least one computing device. In some embodiments, at least one user may interact with the client user interfaces 845, 846 using at least one input device integrated with or communicatively coupled to the at least one computing device, wherein the input device may comprise at least one of a keyboard, a keypad, a touchscreen, a pointing device, a microphone, a motion detector, a camera, or an accelerometer, as non-limiting examples.

In some aspects, the client user interface 845 may comprise a display of all current tasks, projects, activities, or outstanding items, as non-limiting examples, and their associated point value 820. In some implementations, the client user interface 845 may comprise a visible indication of how many available points 810 the client may possess. In some embodiments, the client user interface 845 may comprise a status of overall projects, a status of provided or pending deliverables, milestones, responsibilities, or timelines, to facilitate client control of work and point 810 usage, as non-limiting examples. In some implementations, the client user interface 845 may enable a client to maintain control of work and point 810 usage, adjust one or more project requests in real-time, provide feedback, communicate any requested or relevant information, or request changes to project or task scope or priorities, as non-limiting examples. In some aspects, one or more notes or progress indicators, as non-limiting examples, may be visibly associated with each relevant task, project, or activity.

In some embodiments, the client user interface 846 may comprise an explicit associative display of one or more points 810 and their currency-correlated point value 820. In some implementations, the client user interface 846 may comprise one or more predetermined methods for enabling at least one point purchase transaction. As a non-limiting illustrative example, the client user interface 846 may allow the client to establish a secure connection with a bank account, pay with a credit or debit card, input a payment code received from a previous in-person cash transaction, or transmit any similar electronic payment, as non-limiting examples. In some aspects, the client user interface 846 may comprise one or more bundle options for point purchases. As a non-limiting illustrative example, the client user interface 846 may comprise options to point 810 sets of five, ten, or fifteen points 810.

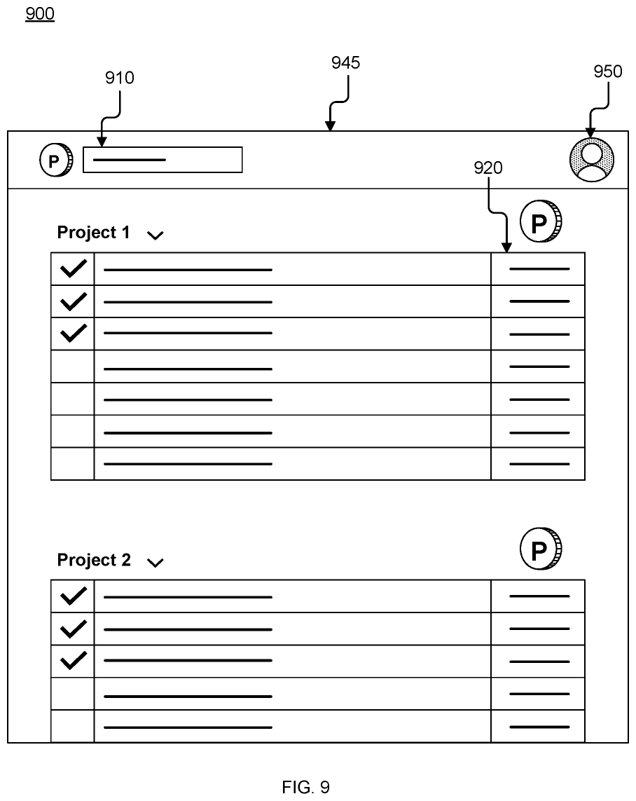

Referring now to FIG. 9, an exemplary employee user interface 945, according to some embodiments of the present disclosure, is illustrated. In some implementations, the employee user interface 945 may be generated and presented by a productivity measurement system 900. By way of example and not limitation the employee user interface 945 may be presented via at least one display screen integrated with or communicatively coupled to at least one computing device. In some embodiments, at least one user may interact with the employee user interfaces 945 using at least one input device integrated with or communicatively coupled to the at least one computing device, wherein the input device may comprise at least one of: a keyboard, a keypad, a touchscreen, a pointing device, a microphone, a motion detector, a camera, or an accelerometer, as non-limiting examples.

In some aspects, the employee user interface 945 may be configured to display one or more checklists for one or more tasks, projects, or activities that need to be completed. In some implementations, an authorized employee 950 may interact with the checklists using at least one input device. By way of example and not limitation, an employee 950 may mark what they have accomplished or completed on a project checklist.

In some embodiments, the employee user interface 945 may be configured to display one or more point values 920 associated with one or more tasks. In some aspects, this displayed association may assist the employee 950 in prioritizing the amount of time spent per task. In some implementations, the employee 950 may signify that a task has been completed by a completion indictor similar to a checkbox or radio button. In some embodiments, the completed tasks may be submitted to a supervisor for review and approval before the employee 950 receives the allotted points 910 associated with the point value 920 of the task. In some implementations, the employee user interface 945 may comprise at least one numeric display that indicates the quantity of points 910 received by the employee. In some aspects, the quantity of points 910 may be directly or indirectly associated with the productivity of the employee 950. In some embodiments, the quantity of points 910 may reset at a predetermined time interval or similar predetermined occurrence.

In some aspects, an employee 950 may request new proposals, access new engagements, learn about new clients, access new projects, or access new deliverables with minimal inputs and streamlined or automated outputs using the employee user interface 945, as non-limiting examples. In some implementations, the employee user interface 945 may be configured to enable users to create custom dashboards to view critical information pertinent to each unique user. By way of example and not limitation, a sales person may be able to see proposals or check the status of pending transactions, while a different employee 950 may see a point 910 goal or overdue tasks or projects, as non-limiting examples.

As a non-limiting illustrative example, an employee 950 may receive a point 910 goal of ten points 910 for a week. In some aspects, the employee 950 may decide to prioritize work on tasks that are associated with a higher volume of points 910 and thereby complete a plurality of tasks that amount to an equivalent of 12 points 910. In some implementations, this high quantity of points 910 may indicate a high level of performance for the employee 950 for the relevant week. In some aspects, at the start of the following week the point 910 amount may reset to zero with the goal for the employee 950 being to achieve a minimum of ten points 910 to meet the weekly goal.

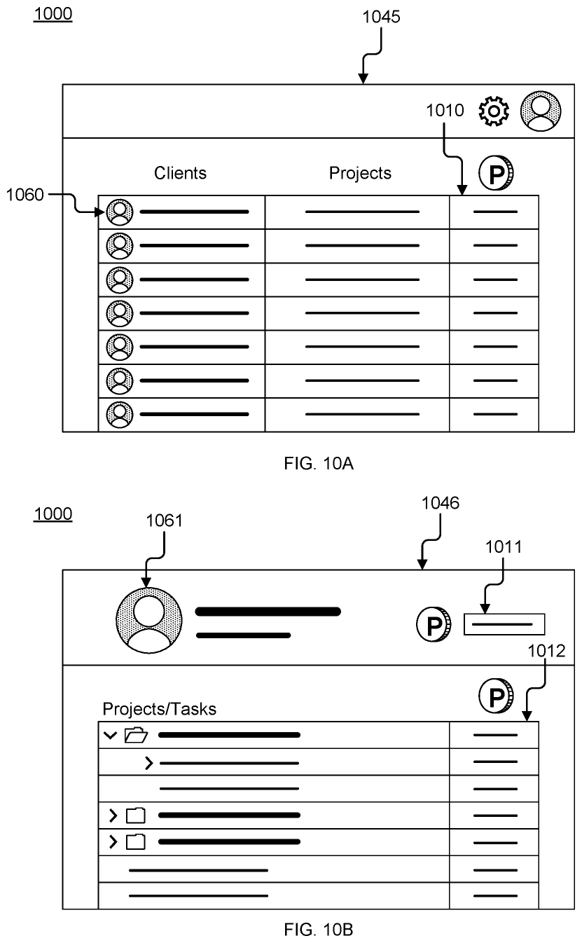

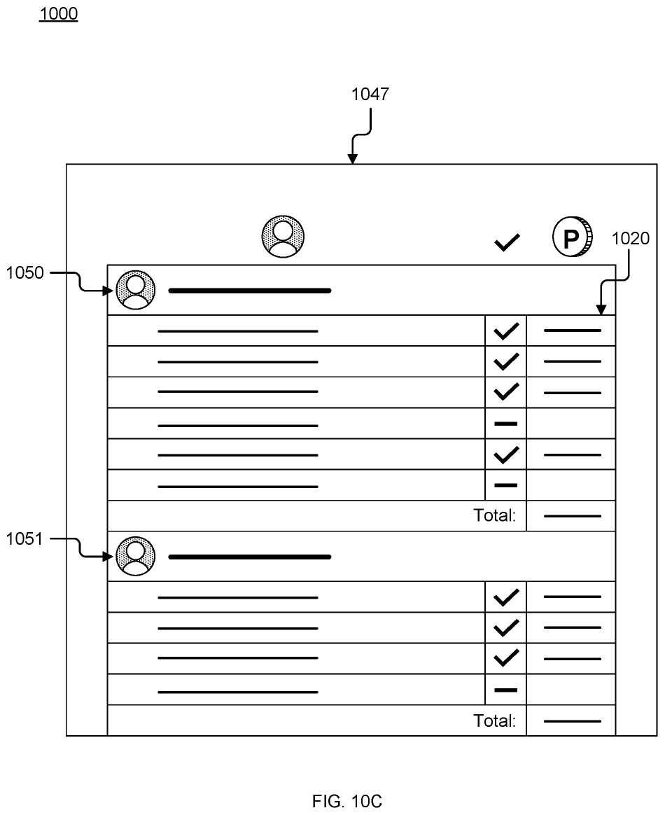

Referring now to FIGS. 10A-10C, exemplary administrative user interfaces 1045, 1046, 1047, according to some embodiments of the present disclosure, are illustrated. In some implementations, the administrative user interfaces 1045, 1046, 1047 may be generated and presented by a productivity measurement system 1000. By way of example and not limitation the administrative user interfaces 1045, 1046, 1047 may be presented via at least one display screen integrated with or communicatively coupled to at least one computing device. In some embodiments, at least one user may interact with the administrative user interfaces 1045, 1046, 1047 using at least one input device integrated with or communicatively coupled to the at least one computing device, wherein the input device may comprise at least one of: a keyboard, a keypad, a touchscreen, a pointing device, a microphone, a motion detector, a camera, or an accelerometer, as non-limiting examples.

In some aspects, the administrative user interface 1045 may comprise at least one chart or similar structured presentation format that may be configured to displays one or more customers, patrons, or clients 1060, one or more projects and/or points 1010 associated therewith, or other non-limiting examples. In some embodiments, the administrative user interface 1045 may comprise a view that presents a plurality of clients 1060 and the point 1010 balance associated therewith. In some implementations, the administrative user interface 1045 may be configured to present one or more types or forms of relevant client 1060 information in one or more of a plurality of views. As a non-limiting illustrative example, the administrative user interface 1045 may comprise a list of clients 1060 and one or more respective projects associated therewith. In some aspects, an expanded view comprising project details may be displayed upon receiving a selection from a user of a client 1060 or the points 1010 of the client 1060, as non-limiting exemplary options.

In some aspects, the administrative user interface 1045 may comprise a settings tab configured to control one or more variables of the administrative user interface 1045. In some implementations, the settings tab may allow an administrative user to implement one or more suggested changes to one or more point values. In some non-limiting exemplary embodiments, one or more suggested point value changes may be at least partially generated or produced by at least one analytical algorithm that may be configured to monitor active use of a provider's points 1010. In some aspects, the adaptive nature of the productivity measurement system 1000 to the provider's needs may facilitate more accurate productivity measurement than an inflexible billable hour model.

In some embodiments, the administrative user interface 1045 may comprise at least one unique profile for at least one administrative user within the administrative user interface 1045. In some implementations, the administrative user may insert one or more notes associated with one or more projects related tasks for one or more clients 1060. By way of example and not limitation, the administrative user may update a client 1060 directly regarding a project overview via the administrative user interface 1045.

In some aspects, an administrative user may use an administrative user interface 1046 to view at least one profile for at least one customer, patron, or client 1061. In some implementations, the administrative user may send the client 1061 one or more direct messages, check the quantity of available points 1011 for the client 1061, or update one or more tasks associated with a project via the administrative user interface 1046, as non-limiting examples. In some embodiments, the administrative user interface 1046 may enable the administrative user to review the project history for a client 1061. In some implementations, an administrative user may use the administrative user interface 1046 to view any comments regarding any projects, tasks, or activities for a client 1061.

In some aspects, the administrative user interface 1046 may be configured to display one or more analytics generated by at least one computational algorithm for the productivity measurement system 1000. In some embodiments, the algorithm may be configured to generate one or more recommendations that may be presented to the administrative user via at least one computing device regarding one or more future projects a client 1061 might be interested in. In some implementations, the algorithm may comprise one or more active machine learning processes that may be configured to revise the point value of one or more tasks, projects, or activities based at least partially on one or more performance metrics or common or frequent requests from the client 1061, as non-limiting examples. In some aspects, this revision process may allow the productivity measurement system 1000 to comprise an adaptive measurement aspect that includes the complexities of performance that may be difficult to capture in detail using a billable hour model.

As a non-limiting illustrative example, the algorithm may comprise at least one machine learning process that further comprises at least one numeric trigger to recognize one or more patterns of repetition. In some aspects, by utilizing machine learning, the algorithm may identify that a client 1061 has purchased research related projects once a month for the last six months. In some implementations, the algorithm may use this insight as the basis to generate at least one recommendation to at least one administrative user of the productivity measurement system 1000, wherein the recommendation may at least partially comprise a subscription-based purchase of points 1011 for the client 1061. Furthermore, the recommendation may comprise a reduction in point value for research-based projects for the client 1061 when the projects are purchased as a bulk purchase. In some non-limiting exemplary embodiments, the machine learning process of the algorithm may generate this incentivization to improve the statistical probability of additional point purchases by the client 1061. In some implementations, the machine learning process may recommend that someone internal to the organization of the provider reach out to existing clients 1061 whose point 1011 usage is not on track to either increase or decrease the point 1011 quantity of the relevant subscription.

In some aspects, the administrative user interface 1047 may comprise one or more types of summary information in one or more structural configurations or layouts for one or more selected workers or employees 1050, 1051. In some implementations, an administrative user may use the administrative user interface 1047 to view one or more current projects, completed tasks, and associated point values 1020 for one or more workers or employees 1050, 1051, as non-limiting examples. In some embodiments, the administrative user interface 1047 may comprise a communication system that allows an administrative user to communicate directly with an employee 1050, 1051.

In some implementations, an administrative user may use the administrative user interface 1047 to view the quantity of points an employee 1050, 1051 has earned or is earning per task or per project. In some aspects, an administrative user may view a quantity of points earned by a group of employees 1050, 1051 for a project. In some embodiments, viewing points by project for a group of employees may allow the administrative user to view and assess the contribution to an individual project made by each employee 1050, 1051 and evaluate the distribution of the project workload during the execution of the associated tasks.

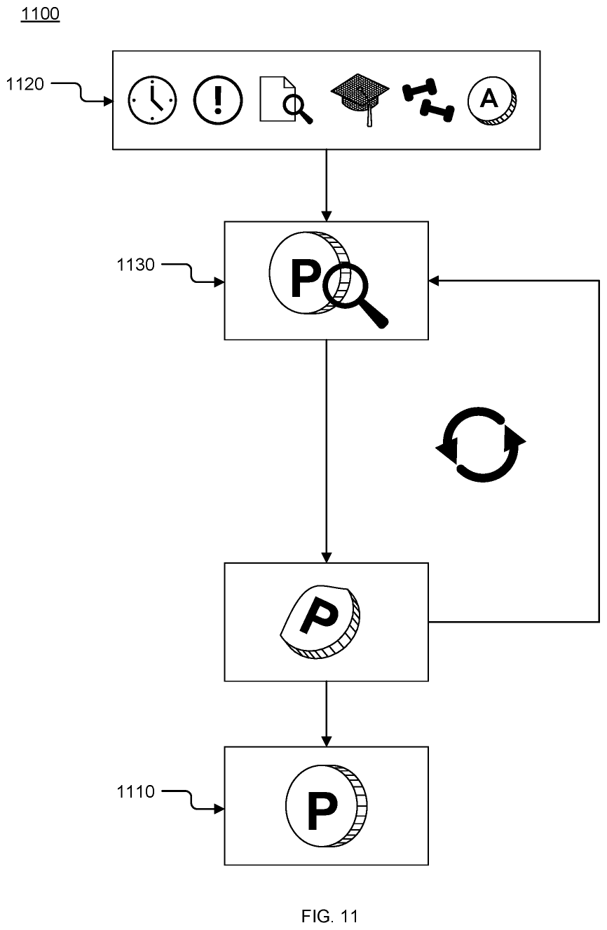

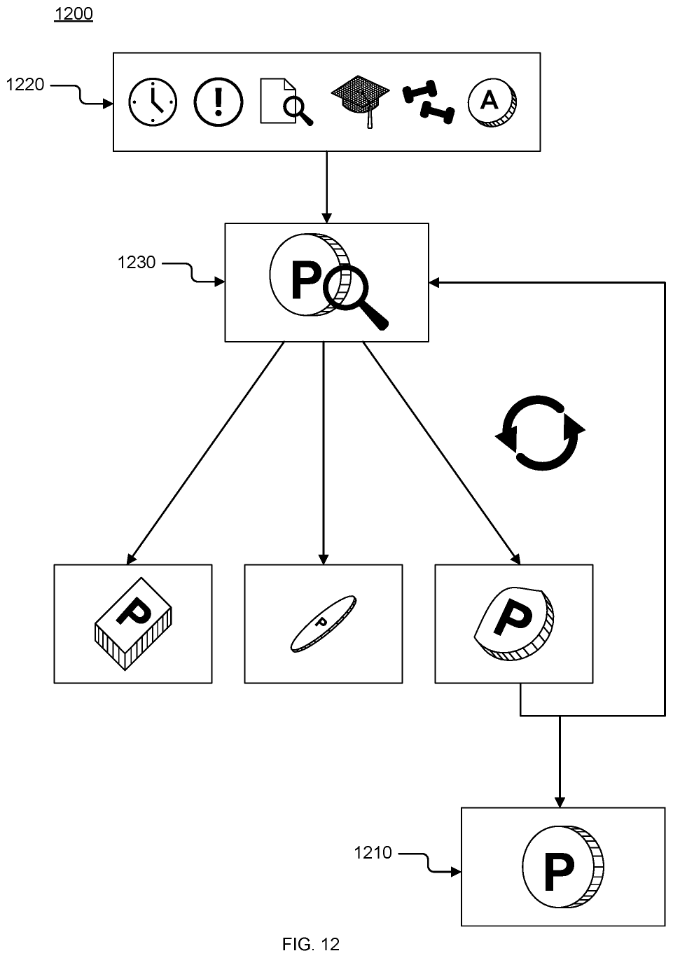

Referring now to FIG. 11, a diagram for an exemplary machine learning process for a point value system 1100, according to some embodiments of the present disclosure, is illustrated. In some aspects, at least one machine learning process may be used in the point value system 1100 to determine one or more point values 1120. In some aspects, the point value system 1100 may comprise at least one algorithm 1130 configured to execute or at least partially facilitate at least one machine learning process. In some embodiments, the algorithm 1130 may utilize one or more previously defined point values 1120 to form a frame of reference for point value 1120 assignment within at least one program received by the point value system 1100 from at least one provider. In some aspects, the adaptive nature of the point value system 1100 may facilitate a responsive aspect to the pricing of one or more goods or services available from the provider that may be lacking in a linear billable hour model.

As a non-limiting illustrative example, the algorithm 1130 may begin forming or generating a point value 1120 definition at the previous concluding point value definition and reiterate the definitive correlation by integrating the new variables and frequency of occurrence introduced by the program. In some aspects the algorithm 1130 may utilize at least one machine learning process to recognize or identify one or more patterns of occurrence and frequency within the program and, by comparing this information with previously established point correlations, provide an estimate of one or more basic point values 1120 for the program.

In some embodiments, the machine learning process may actively continue to monitor and suggest point value 1120 alterations in response to one or more aspects associated directly or indirectly with the use of the point value system 1100. In some implementations, active monitoring of the utilization of the point value system 1100 by the provider may occur after the algorithm 1130 has performed an initial analysis and proposed one or more point values 1120 that correlate with a program's identified priorities.

Referring now to FIG. 12, a diagram for an exemplary machine learning process for a point value system 1200, according to some embodiments of the present disclosure, is illustrated. In some aspects, the point value system 1200 may be configured to generate or produce a plurality of point values 1220 using at least one algorithm 1230. As a non-limiting illustrative example, by utilizing the machine learning method outlined in FIG. 11, the point value 1220 may be determined for a plurality of repetitive components within a program such as drafting, revising, negotiating, counseling, advising, collaborating, research, time, and other non-limiting examples. In some implementations, the algorithm 1230 may be configured to use these point values 1220 to determine a plurality of additional point values 1220. By way of example and not limitation, the point values 1220 may determine the point values 1220 for five points 1210 and a portion of a point 1210. In some aspects, multiples of the calculated point values 1220 may be presented as options for purchasing points 1210 in larger quantities.

In some embodiments, the machine learning process may actively continue to monitor and/or suggest point value 1220 alterations in response to one or more real-time interactions between a provider and the point value system 1200. As a non-limiting illustrative example, a law firm may perform initial consultations less often than normal in a given month and the point value system 1200 may suggest lowering the point value 1220 of an initial consultation after detecting the trend of declined frequency. In some aspects, this responsive and active adjustment of the point value system 1200 may facilitate an adaptive pricing and productivity model that may be lacking from a billable hour model.

In some implementations, active monitoring of the utilization of the point value system 1200 by a provider may occur after the algorithm 1230 has performed at least one initial analysis and proposal for point values 1220 that correlate with a program's priorities.

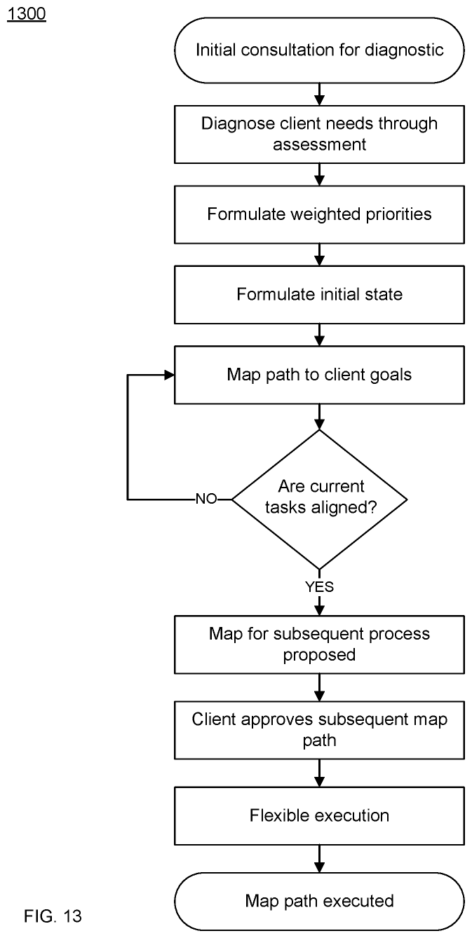

Referring now to FIG. 13, an exemplary flow diagram for the generation of points for a point value system, according to some embodiments of the present disclosure, is illustrated. In some embodiments, a provider may attend an initial consultation wherein the scope of the provider's intent may be defined. In some implementations, the initial consultation may at least partially comprise a software component that may comprise one or more coded instructions stored within at least one storage medium and accessed and executed by at least one processor of at least one computing device. In some embodiments, the software component may be stored within the computing device itself or the software component may be stored within one or more servers and accessed by the computing device via at least one network connection, at least one near-field communication connection, or at least one short-range wireless interconnection, as non-limiting examples. In implementations, the software component may at least partially comprise at least one adaptive algorithm. In some aspects, the algorithm may comprise one or more assessments and/or a weighted stack ranking of priorities, as non-limiting examples.

In some embodiments, the algorithm may at least partially facilitate the conversion of one or more billable hour metrics from an existing company infrastructure into one or more deliverable-based metrics. In some aspects, the billable hour metrics may be received from a provider, such as, for example and not limitation, by being imported from at least one program of the provider. By way of example and not limitation, billable hour metrics may comprise an hourly rate, an average project or task completion time, or similar factors, as non-limiting examples. In some implementations, the conversion to deliverable-based metrics may at least partially comprise one or more quantitative and/or qualitative values for parameters or attributes associated with the generation or production of one or more deliverables, such as worker or employee effort, complexity of the task or project, urgency of the task or project, or worker or employee expertise, as non-limiting examples. In some embodiments, these values may improve the accuracy associated with labor and project or task estimates for the provider's services or product generations over a conventional billable hour model. In some aspects, one or more points for at least one point value system may be at least partially determined based at least partially on the deliverable-based metrics.

In some aspects, the algorithm may at least partially comprise at least one analysis of one or more responses to one or more queries, which may allow the algorithm to develop an artificial intelligence model that may be able to identify or understand one or more goals, priorities, and/or pain points of the provider, as non-limiting examples of attributes. In some embodiments, the algorithm may be configured to generate one or more types of high level information that may be presented to the provider and that may be relevant to or directly or indirectly associated with one or more needs of the provider, such as one or more depictions of a provider journey or a business model canvas, as non-limiting examples.

In some implementations, the algorithm may be configured to generate or formulate an assessment or evaluation of an initial state of the provider's resources and business plan, as non-limiting examples, and generate and present at least one map path to one or more predetermined goals of the provider. In some aspects, the algorithm may comprise an active monitoring protocol that assesses the completion state of current tasks or projects and evaluates the alignment of these tasks or projects with the predetermined goals of the provider's map path.

In some embodiments, this assessment may allow the provider to receive one or more insights into one or more indicators of productivity for the provider's workers or employees. In some implementations, the algorithm may produce an associative point value system to quantify one or more productivity and deliverable metrics. In some aspects, the point value system may facilitate progress measurement based on one or more deliverables or outcomes. In some embodiments, the point value system may facilitate progress measurement independent of time.

In some implementations, the point value system may comprise a plurality of point value systems for internal use as well as customer transactions. In some embodiments, the point value system may be configured to adaption new data or circumstances via one or more machine learning processes based at least partially upon one or more current task attributes or rates of project or task completion, as non-limiting examples of characteristics.

In some aspects, the algorithm may comprise a plurality of map paths that may indicate the provider's process improvement over time. In some embodiments, the pace or rate of the production of map paths may be controlled via one or more inputs received from the provider. In some implementations, the provider may be able to submit approval for one or more phases depicted by one or more map paths. In some implementations, one or more templates of standard map paths may be available and adaptable by the provider.

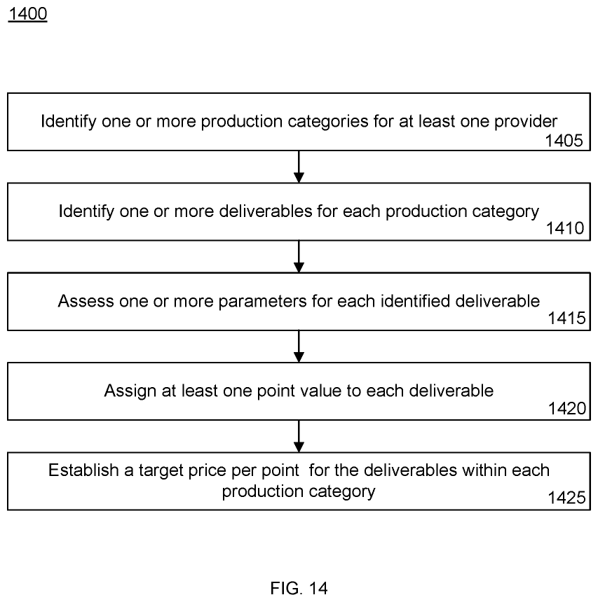

Referring now to FIG. 14, methods steps for an exemplary process 1400 for developing a point value system for a provider, according to some embodiments of the present disclosure, are illustrated. In some non-limiting exemplary implementations, process 1400 may be at least partially facilitated by a productivity measurement system, wherein the productivity measurement system may comprise at least one computing device that comprises at least one storage medium and at least one processor, wherein the storage medium may comprise one or more coded instructions or algorithms that may be executed by the processor to cause the processor to perform one or more steps or portions of steps of process 1400.

In some aspects, at 1405, one or more production categories may be identified for at least one provider. In some implementations, a production category may comprise a grouping of one or more projects, tasks, activities, services, or similar deliverables that may be offered by the provider and may be available to one or more actual or potential clients, customers, patrons, or similar recipients for purchase, sale, transfer, or similar transaction. By way of example and not limitation, a production category may comprise a matter or business affair handled or tended to by the provider on behalf of a client or customer. In some non-limiting exemplary embodiments, each identified production category may be received by a productivity measurement system via at least one input device integrated with or communicatively coupled to at least one computing device. In some aspects, the productivity measurement system may comprise one or more machine learning algorithms or artificial intelligence infrastructures that may be configured to determine or suggest one or more production categories based at least partially on the provider's name, industry, business type, or similar factors, as non-limiting examples.

In some implementations, at 1410, one or more deliverables may be identified for each identified production category. By way of example and not limitation, a deliverable may comprise a project, task, activity, or service that may be completed, performed, or executed during the course of engagement of a production category by the provider. In some aspects, a plurality of deliverables may be identified for a production category. In some non-limiting exemplary embodiments, the plurality of deliverables may comprise every deliverable related to or associated with the production category. In some non-limiting exemplary implementations, one or more of the identified deliverables may be received by a productivity measurement system via at least one input device integrated with or communicatively coupled to at least one computing device. In some embodiments, the productivity measurement system may comprise one or more machine learning algorithms or artificial intelligence infrastructures that may be configured to determine or suggest one or more deliverables based at least partially on the provider's name, industry, business type, one or more additional or previously identified deliverables, or similar factors, as non-limiting examples.

In some aspects, at 1415, one or more actual or potential parameters may be assessed for each identified deliverable. In some non-limiting exemplary implementations, a parameter may be variable, such that the variable parameter may have to be assessed at the time the associated deliverable is to be completed. In some embodiments, a plurality of contingent parameters may be assessed for a deliverable, such that the deliverable may comprise a plurality of unique parameter sets, each of which may correspond to different circumstances. By way of example and not limitation, each parameter may comprise one or more of: the size, scope, or completion time of the deliverable; the complexity of the deliverable; a risk level associated with the deliverable; a value associated with or provided by the deliverable; or an urgency associated with completion, execution, or performance of the deliverable, as non-limiting examples. In some aspects, one or more of the parameters assessed for a deliverable may be determined relative to the application of those same parameters to other deliverables in the relevant production category.

In some non-limiting exemplary embodiments, one or more parameter assessments may be received by a productivity measurement system via at least one input device integrated with or communicatively coupled to at least one computing device. In some aspects, the productivity measurement system may comprise one or more machine learning algorithms or artificial intelligence infrastructures that may be configured to identify and/or assess one or more of the parameters in an at least partially autonomous manner at least partially based, for example and not limitation, on one or more previously assessed parameters for similar deliverables and/or production categories.

As a non-limiting illustrative example, a provider may comprise a law firm, and an identified production category for the law firm may comprise business formation services. In some aspects, the production category may comprise a plurality of deliverables including but not limited to contract preparation, email drafting, consulting, and the arrangement of licensing agreements. In some implementations, the size and scope of email drafting may be low compared to the other deliverables. In some embodiments, contract preparation may comprise a low scope with high complexity as well as a relatively high risk level for the client, whose future business success may hinge on precise and accurate wording within a contract. In some implementations, a licensing agreement may comprise a large project size but may comprise a relatively low complexity as large portions of the licensing agreement may comprise standard or template language. In some aspects, consulting services may comprise low complexity, low risk, and a small size but may offer a significant amount of value to a client. In some embodiments, any of the deliverables within the production category may comprise a high urgency when requested or required within a condensed timeframe.

In some implementations, at 1420, at least one point value may be assigned to each deliverable within the production category based at least partially on at least one portion of the assessed parameters associated with the deliverable. In some non-limiting exemplary embodiments, a first deliverable may be identified as a baseline deliverable, wherein the baseline deliverable may comprise one point. In some aspects, any deliverable(s) within the production category that comprise assessed parameter(s) that are simians to the baseline deliverable may also be assigned one point. In some implementations, each of the other deliverables within the production category may be assigned a point that is greater than or less than one depending on whether the assessed parameters of the relevant deliverable are determined to require more or less work, effort, or resources of the provider compared to the baseline deliverable.

In some non-limiting exemplary embodiments, the point value of the baseline deliverable and/or one or more of the other deliverables may be at least partially determined by a productivity measurement system. In some aspects, the productivity measurement system may comprise one or more machine learning algorithms or artificial intelligence infrastructures that may be configured to determine or suggest one or more point values for one or more deliverables based on one or more previously assessed parameters that may used to weight each deliverable relative to the other deliverables within the production category or based on point values assigned to similar deliverables associated with other production categories or providers, as non-limiting examples.

In some aspects, at 1425, a target price per point for the deliverables within each production category may be established. In some non-limiting exemplary implementations, the price per point may be at least partially based on a determination or identification of the price of the baseline deliverable available from the deliverable, wherein the price of the baseline deliverable may comprise the price per point for all deliverables within the associated production category. In some embodiments, the established price per point may be applied to the point value assigned to each deliverable to determine a price for each deliverable such that the provider may be able to assess whether the deliverable price is fair, accurate, or reasonable within the provider's business model. In some aspects, the price of one or more of the deliverables within the production category may comprise a potential price range instead of a specified price so that the provider may determine a unique price for such deliverables based on one or more unique circumstances. By way of example and not limitation, the median price within the price range may comprise the established price per point multiplied by the point(s) assigned to the relevant deliverable.

In some non-limiting exemplary embodiments, the target price per point may be at least partially determined by a productivity measurement system. In some aspects, the productivity measurement system may comprise one or more machine learning algorithms or artificial intelligence infrastructures that may be configured to determine or suggest a targeted price per point based at least partially on similar targets associated with other production categories or providers or based at least partially on historical pricing data associated with the deliverables within the relevant production category, as non-limiting examples.

As a non-limiting illustrative example, a provider comprising a law firm may assign two points to a deliverable comprising preparation of a contract. In some aspects, the law firm may establish a target price per point of $2,500. In some implementations, instead of using the two points assigned to the contract to determine the price of the contract to be $5,000, the law firm may set the price of deliverables comprising contracts to range from $4,000 to $6,000 to account for different variable parameters such as complexity and urgency, as non-limiting examples. In some non-limiting exemplary embodiments, the provider may refer to one or more types or sources of historical data when assigning points to deliverables or establishing a price per point or a deliverable price range, as non-limiting examples. By way of example and not limitation, the provider may refer to previously established deliverable prices when assessing a targeted price per point to determine whether the price per point causes an expected price to be realized when applied to the point(s) assigned to an individual deliverable.

As a non-limiting illustrative example, a provider comprising a law firm may have previously used a billable hour model for pricing deliverables. Historically, the law firm may have billed contract preparation services at $300 per hour, and the average time to prepare a contract may have been about five hours, for an average contract preparation price of $1,500. In some aspects, the firm may use a point value system to assign one point to contract preparation with a targeted price per point of $1,000, causing the total price for preparing a contract to be only $1,000. In some implementations, by referring to the historical contract preparation pricing data of $1,500, the law firm may determine that the new price of $1,000 is too low and therefore the law firm may adjust the points assigned to contract preparation and/or the targeted price per point of deliverables within the relevant production category, as non-limiting examples.

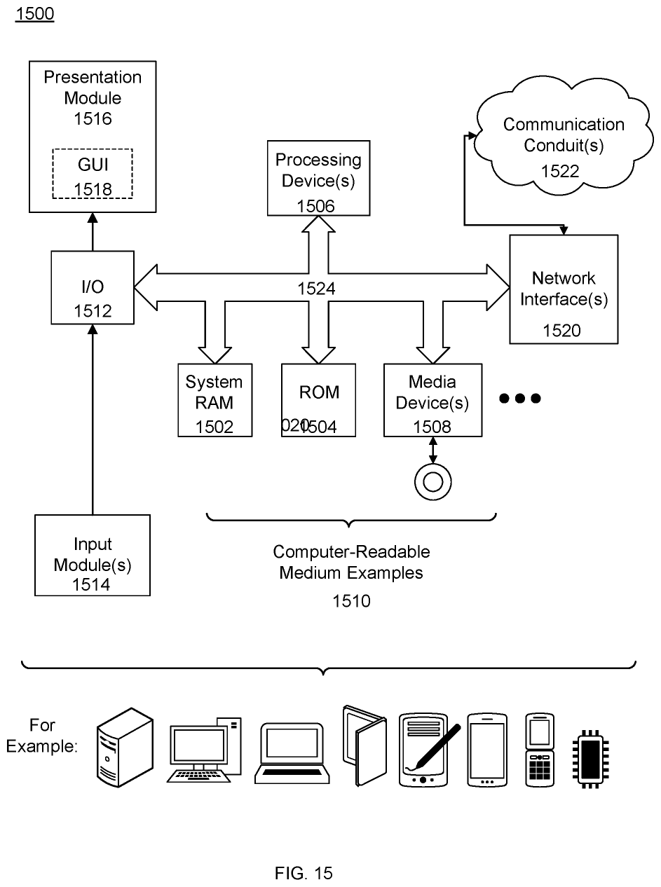

Referring now to FIG. 15, an exemplary computing system that may be used to implement computing functionality 1500 for one or more aspects of a productivity measurement system, according to some embodiments of the present disclosure, is illustrated. In some aspects, in all cases computing functionality 1500 may represent one or more physical and tangible processing mechanisms. Computing functionality 1500 may comprise volatile and non-volatile memory, such as RAM 1502 and ROM 1504, as well as one or more processing devices 1506 (e.g., one or more central processing units (CPUs), one or more graphical processing units (GPUs), and the like). Computing functionality 1500 also optionally comprises various media devices 1508, such as a hard disk module, an optical disk module, and so forth. Computing functionality 1500 may perform various operations identified above when the processing device(s) 1506 execute(s) instructions that are maintained by memory (e.g., RAM 1502, ROM 1504, and the like).

More generally, instructions and other information may be stored on any computer readable medium 1510, including, but not limited to, static memory storage devices, magnetic storage devices, and optical storage devices. The term “computer readable medium” also encompasses plural storage devices. In all cases, computer readable medium 1510 represents some form of physical and tangible entity. By way of example and not limitation, computer readable medium 1510 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 1502, ROM 1504, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 1500 may also comprise an input/output module 1512 for receiving various inputs (via input modules 1514), and for providing various outputs (via one or more output modules). One particular output module mechanism may be a presentation module 1516 and an associated GUI 1518. Computing functionality 1500 may also include one or more network interfaces 1520 for exchanging data with other devices via one or more communication conduits 1522. In some aspects, one or more communication buses 1524 communicatively couple the above-described components together.

Communication conduit(s) 1522 may be implemented in any manner (e.g., by a local area network, a wide area network (e.g., the Internet), and the like, or any combination thereof). Communication conduit(s) 1522 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “service,” “module,” and “component” as used herein generally represent software, firmware, hardware, or any combination thereof. In the case of a software implementation, the service, module, or component represents program code that performs specified tasks when executed on one or more processors. The program code may be stored in one or more computer readable memory devices. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method for developing a point value system for at least one provider, the method comprising:
identifying one or more production categories for the at least one provider;
identifying one or more deliverables for each of the one or more identified production categories;
assessing one or more parameters for each of the one or more identified deliverables;
assigning at least one point value to each of the one or more identified deliverables; and
establishing a target price per point for all of the one or more deliverables within each production category.

2. The method of claim 1, wherein the at least one point value is at least partially based on at least one portion of the one or more assessed parameters.

3. The method of claim 1, the method further comprising:
identifying one of the one or more deliverables as a baseline deliverable, wherein the baseline deliverable comprises a point value of one point.

4. A productivity measurement system, comprising:
at least one computing device, wherein the at least one computing device comprises at least one storage medium and at least one processor, wherein the at least one storage medium comprises at least one algorithm that may be executed by the at least one processor to facilitate the conversion of one or more billable hour metrics into one or more deliverable-based metrics to establish at least one point value system; and
at least one provider, wherein the at least one provider comprises the primary user of the productivity measurement system.

5. The productivity measurement system of claim 4, wherein the at least one algorithm comprises an adaptive algorithm that comprises at least one machine learning process.

6. The productivity measurement system of claim 4, wherein the one or more billable hour metrics are received from the at least one provider.

7. The productivity measurement system of claim 6, wherein the one or more billable hour metrics are imported from at least one program of the at least one provider.

8. The productivity measurement system of claim 4, wherein each of the one or more deliverable-based metrics comprises one or more quantitative and qualitative values for one or more parameters associated with the generation of one or more deliverables.

9. The productivity measurement system of claim 8, wherein each of the one or more parameters comprises at least one of: worker effort, task urgency; task completion time; task complexity; or worker expertise.

10. The productivity measurement system of claim 1, further comprising at least one point, wherein the at least one point comprises a numeric value that comprises a quantified representation of at least one of the one or more deliverable-based metrics.

11. The productivity measurement system of claim 10, wherein the at least one point comprises at least one point value, wherein the at least one paint value comprises the at least one of the one or more deliverable-based metrics associated with the at least one point.

12. The productivity measurement system of claim 11, wherein the at least one point comprises a plurality of the at least one point value.

13. The productivity measurement system of claim 10, wherein the at least one point is purchasable from the at least one provider.

14. The productivity measurement system of claim 13, wherein the at least one point is exchangeable for a predetermined amount of time of the at least one provider.

15. The productivity measurement system of claim 13, wherein the at least one point is exchangeable for one or more deliverables available from the at least one provider.

16. The productivity measurement system of claim 4, wherein the at least one provider comprises one or more of: a corporation, a firm, a business, a company, and an organization.

17. The productivity measurement system of claim 4, wherein the at least one provider comprises one or more workers.

18. The productivity measurement system of claim 4, wherein the productivity measurement system comprises a plurality of the at least one point value system.

19. A method for generating one or more points for a point value system, the method comprising:
importing one or more billable hour metrics from at least one program of at least one provider; and
converting the one or more billable hour metrics to one or more deliverable-based metrics via at least one algorithm.

20. The method of claim 19, further comprising:
generating at least one assessment of an initial state of the at least one provider;
and generating at least one map path from the initial state to one or more predetermined goals of the provider.
